(19) United States
(12) Patent Application Publication
(10) Pub. No.: US 2023/0406989 A1
(43) Pub. Date: Dec. 21, 2023

(54) URETHANE AND REFRIGERATOR COMPRISING SAME

(71) Applicant: SAMSUNG ELECTRONICS CO., LTD., Suwon-si (KR)

(72) Inventors: Mingyu JUNG, Suwon-si (KR); Jongsung PARK, Suwon-si (KR); Youngdeog KOH, Suwon-si (KR); Jungchul KIM, Suwon-si (KR); Jungsoo LIM, Suwon-si (KR)

(73) Assignee: SAMSUNG ELECTRONICS CO., LTD., Suwon-si (KR)

(21) Appl. No.: 18/208,386

(22) Filed: Jun. 12, 2023

Related U.S. Application Data
(63) Continuation of application No. PCT/KR2023/007127, filed on May 25, 2023.

(30) Foreign Application Priority Data
Jun. 20, 2022 (KR) 10-2022-0075202
Aug. 25, 2022 (KR) 10-2022-0107195

(51) Int. Cl. C08G 18/08; F25D 23/06; C08J 9/14; C08G 18/32

(52) U.S. Cl. CPC C08G 18/14; F25D 23/065; C08J 9/149; C08G 18/3215; C08J 2205/052; C08G 2110/005; C08J 2205/044

(57) ABSTRACT

Disclosed are a urethane having improved thermal insulation performance by lowering thermal conductivity of the urethane and a refrigerator comprising the same. The urethane may comprise: a plurality of closed cells containing inside gas; a plurality of open cells connected to outside air; and cell walls disposed between at least one of the plurality of closed cells and at least one of the plurality of open cells or between the plurality of closed cells to connect the at least one of the plurality of closed cells with the at least one of the plurality of open cells or to connect the plurality of closed cells. Diameters of a closed cell of the plurality of closed cells and an open cell of the plurality of open cells may be about 100 to 200 μm.

### CROSS-REFERENCE TO RELATED APPLICATIONS

This application is a continuation of International Application No. PCT/KR2023/007127, filed May 25, 2023, which claims priority to Korean Patent Application Nos. 10-2022-0075202, filed Jun. 20, 2022, and 10-2022-0107195, filed Aug. 25, 2022, the disclosures of each of which are incorporated herein by reference.

### BACKGROUND

### 1. Field

The present disclosure relates to a urethane and a refrigerator comprising the same.

### 2. Description of Related Art

Urethane used as an adiabatic material is injected into a gap between a cabinet and a cavity of a refrigerator in a liquid phase and cured to constitute walls. The lowest thermal conductivity of adiabatic materials formed of conventional urethane is 20 mW/m·K which cannot satisfy environmental regulations that are being strengthened.

To increase thermal insulation effects of adiabatic materials, a method of increasing thickness of urethane has been used. However, in the case of increasing the thickness of urethane, problems such as an increase in size or a decrease in storage capacity occur in refrigerators.

Therefore, there is a need to develop a high-performance urethane having a lower thermal conductivity than those of conventional urethanes to satisfy environmental regulations and minimize inconvenience of consumers.

### SUMMARY

In accordance with an aspect of the present disclosure, a urethane comprises: a plurality of closed cells containing inside gas; a plurality of open cells connected to outside air; and cell walls disposed between at least one of the plurality of closed cells and at least one of the plurality of open cells or between the plurality of closed cells to connect the at least one of the plurality of closed cells with the at least one of the plurality of open cells or to connect the plurality of closed cells, wherein diameters of a closed cell of the plurality of closed cells and an open cell of the plurality of open cells are about 100 to 200 μm.

A thermal conductivity λᵤᵣₑₜₕₐₙₑ may be about 18.0 to 20.5 mW/m·K. The urethane may comprise, in fraction by volume, about 90% or more of the plurality of closed cells and a balance of the plurality of open cells. The gas may comprise cyclopentane (CP), air, and hydrofluoro-olefin (HFO). A density of the urethane is about 30 to 35 kg/m³. An average thickness of the cell walls may be about 0.35 to 0.5 m.

In accordance with another aspect of the present disclosure, a method of manufacturing a urethane comprises: forming a urethane polymer by reacting a polyol solution with isocyanate; and forming cells by adding a blowing agent and a foam stabilizer for cell formation. A catalyst may be used to control reaction rates of the urethane polymer-forming operation and the cell-forming operation. The polyol solution, the isocyanate, the blowing agent, the foam stabilizer, and the catalyst are comprised as follows: about 100 parts by weight of the polyol solution, about 100 to 120 parts by weight of the isocyanate, about 30 parts by weight or less of the blowing agent, about 1 to 3 parts by weight of the foam stabilizer, and about 1 to 8 parts by weight of the catalyst are comprised based on the 100 parts by weight of the polyol solution.

To control the reaction rates, a cream time (CT) may be about 3 to 10 seconds, and a gel time (GT) may be about 20 to 60 seconds. The ratio of gel time (GT) to cream time (CT) may be about 2 to 20. The polyol solution may comprise about 20 to 80 parts by weight of an aromatic polyol solution and a balance of aliphatic polyols based on the 100 parts by weight of the polyol solution. The blowing agent may comprise at least one of cyclopentane (CP), hydrofluoro-olefin (HFO), and hydrofluorocarbon (HFC). The catalyst may comprise about 1 to 3 parts by weight of the foaming catalyst, about 1 to 3 parts by weight of the gelling catalyst, and a balance of the trimerization catalyst based on the 100 parts by weight of the polyol solution. The foaming catalyst may comprise at least one of pentamethyl diethylene triamine (PMDETA) and di-(N,N-dimethyl aminoethyl)ether (BDMEE). The gelling catalyst may comprise at least one of triethylamine (TEA), triethylenediamine (TEDA), pentamethylenediethylene triamine (PMDETA), dimethylcyclohexyl amine (DMCHA), and tetramethyl-n-hexyldiamine (TMHDA). The trimerization catalyst may comprise at least one of potassium otoate and TMR-2.

In accordance with another aspect of the present disclosure, a refrigerator comprises: an outer cabinet; an inner cavity within the outer cabinet; and a urethane between the outer cabinet and the inner cavity. The urethane may comprise a plurality of closed cells containing inside gas; a plurality of open cells connected to outside air; and cell walls disposed between at least one of the plurality of closed cells and at least one of the plurality of open cells or between the plurality of closed cells to connect the at least one of the plurality of closed cells with the at least one of the plurality of open cells or to connect the plurality of closed cells. Diameters of a closed cell of the plurality of closed cells and an open cell of the plurality of open cells may be about 100 to 200 μm.

### BRIEF DESCRIPTION OF THE DRAWINGS

FIG. 1 is a scanning electron microscope (SEM) image of a cross-section of a urethane according to an embodiment.

FIG. 2 is a schematic diagram illustrating a cross-section of a refrigerator according to an embodiment.

### DETAILED DESCRIPTION

Hereinafter, embodiments of the present disclosure will be described in detail with reference to the accompanying drawings. These embodiments are provided to fully convey the concept of the present disclosure to those of ordinary skill in the art. The present disclosure may, however, be embodied in many different forms and should not be construed as limited to the exemplary embodiments set forth herein. In the drawings, parts unrelated to the descriptions are omitted for clear description of the disclosure and sizes of elements may be exaggerated for clarity.

Throughout the specification, the term “comprising” or “including” an element specifies the presence of the stated element, but does not preclude the presence or addition of one or more elements, unless otherwise stated.

An expression used in the singular encompasses the expression of the plural, unless otherwise indicated.

To solve various problems including the above problems, provided are a urethane having improved thermal insulation performance by lowering thermal conductivity via urethane cell refinement conducted by controlling a reaction time of the urethane, and a refrigerator including the same.

According to one embodiment, a urethane having improved thermal insulation performance by lowering thermal conductivity of the urethane via cell refinement conducted by controlling a reaction time and a refrigerator including the same may be provided.

However, the effects achieved by the urethane and the refrigerator including the same according to the embodiments of the present disclosure are not limited to those mentioned above, and any other effects not mentioned herein will be understood by those skilled in the art to which the present disclosure belong.

A urethane according to an embodiment may comprise a plurality of closed cells containing inside gas; a plurality of open cells connected to outside air; and cell walls disposed between the closed cells and the open cells or between the plurality of closed cells to connect the closed cells with the open cells or to connect the plurality of closed cells.

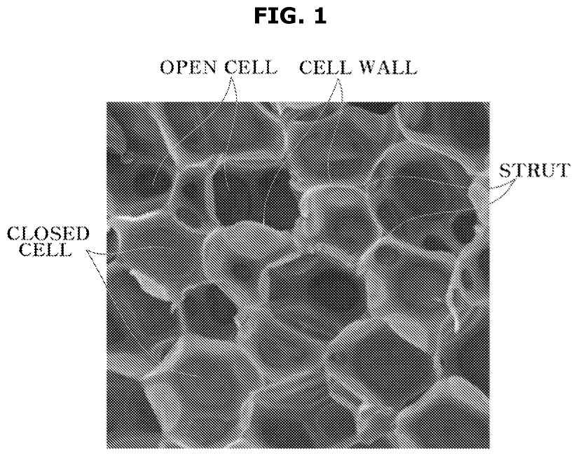

FIG. 1 is a scanning electron microscope (SEM) image of a cross-section of urethane according to an embodiment.

Referring to FIG. 1, the urethane according to an embodiment comprises a plurality of open cells, a plurality of closed cells, and cell walls.

The closed cells refer to closed pores containing inside gas generated while the urethane is foamed. The open cells refer to open pores failing to form closed cells and connected to outside air.

The cell walls refer to a structure disposed between the closed cells and the open cells or between the plurality of closed cells to connect the closed cells with the open cells or to connect the plurality of closed cells. In addition, a strut refers to a point at which three or more closed cells or open cells meet.

Diameters of a closed cells of the plurality of closed cells and an open cell of the plurality of open cells may be about 100 to 200 μm.

Thermal conductivity of the urethane λᵤᵣₑₜₕₐₙₑ determining thermal insulation performance of the urethane may be calculated using Equation (1) below.

λᵤᵣₑₜₕₐₙₑ=λ_{gas}+λ_{solid}+λ_{radiation}+λ_{convection} Equation (1):

The thermal conductivity of the urethane λᵤᵣₑₜₕₐₙₑ may be calculated as a sum of a thermal conductivity of the inside gas λ_{gas} contained in the closed cells, a thermal conductivity of the cell walls λ_{solid}, a thermal conductivity by radiant energy λ_{radiation} generated throughout the cell walls and the inside gas, and a thermal conductivity of a convection current λ_{convection} generated by circulation of the inside gas. However, the thermal conductivity of the convection current, which is known to have little effects in the urethane, is not considered in calculation of the thermal conductivity of the urethane λᵤᵣₑₜₕₐₙₑ in the present disclosure.

To lower the thermal conductivity of the urethane λᵤᵣₑₜₕₐₙₑ, the thermal conductivity of the inside gas λ_{gas}, the thermal conductivity of the cell walls λ_{solid}, and the thermal conductivity by radiant energy λ_{radiation} should be lowered.

In the present disclosure, the thermal conductivity by radiant energy radiation is lowered by reducing the diameters of the cells, and the thermal conductivity of the inside gas λ_{gas}, and the thermal conductivity of the cell walls λ_{solid} have similar values to those of the related art. That is, the λ_{gas} may have a value of about 14 to 15 mW/m·K, and the λ_{solid} may have a value of about 2.5 to 3.5 mW/m·K.

The thermal conductivity by radiant energy λ_{radiation} may be represented by Equation (2) below.

$${λ}_{r a d i a t i o n} = \frac{16 \cdot σ \cdot {T}^{3}}{3 \cdot K} \qquad Equation ( 2 )$$

In Equation (2), K may be represented by Equation (3) below.

$$K = 4 , 10 \cdot \frac{\sqrt{\frac{{f}_{s} \cdot {ρ}_{f}}{{ρ}_{z}}}}{d} + [ \frac{( 1 - {f}_{s} ) \cdot {ρ}_{f}}{{ρ}_{z}} ] \cdot {K}_{w} \qquad Equation ( 3 )$$

In Equation (3), fₛ may be represented by Equation (4) below.

$${f}_{s} = 1 - ( \frac{3.46 t {ρ}_{s}}{d {ρ}_{f}} ) \qquad Equation ( 4 )$$

In Equations (2) and (3) above, σ represents Stefan-Boltzmann constant, T represents temperature, K represents extinction coefficient, fₛ represents strut fraction, ρ_{f} represents density of foamed urethane, ρₛ represents density of a solid-state, non-foamed urethane, d represents average diameter of closed cells, K_{w} represents extinction coefficient of cell walls, and t represents average thickness of the cell walls.

Meanwhile, 5.6704*10⁻⁸ W/m²·K is substituted for the Stefan-Boltzmann constant σ, 296 K is substituted for the temperature T, 1250 kg/m³ is substituted for the ρₛ (density of a solid-state, non-foamed urethane), and 60000 m⁻¹ is substituted for the K_{w} (extinction coefficient of the cell walls) in the calculation.

The density pf of foamed urethane should be increased and the average diameter d of the closed cells should be reduced to lower the thermal conductivity by radiant energy λ_{radiation}. Also, the thermal conductivity by radiant energy λ_{radiation} is calculated as an almost same value regardless of increases or decreases in the average thickness t of the cell walls.

As used in the present disclosure, the “average” means an average of values measured at five random points.

In the present disclosure, the thermal conductivity of the urethane is lowered by reducing the diameters of the closed cells and the open cells by optimizing the reaction rate. Particularly, by controlling a cream time (CT), a gel time (GT), and a GT/CT ratio, refinement of the closed cells and the open cells may be obtained.

According to an embodiment a thermal conductivity λᵤᵣₑₜₕₐₙₑ is about 18.0 to 20.5 mW/m·K. Preferably, the thermal conductivity λᵤᵣₑₜₕₐₙₑ may be about 18.0 to 20.0 mW/m·K, and more preferably, the thermal conductivity λᵤᵣₑₜₕₐₙₑ may be about 18.0 to 19.0 mW/m·K.

In addition, the urethane according to an embodiment may comprise, in fraction by volume, about 90% or more of the plurality of closed cells and a balance of the plurality of open cells.

Meanwhile, the inside gas may comprise cyclopentane (CP), air, and hydrofluoro-olefin (HFO).

A density of the urethane may be about 30 to 35 kg/m³, and an average thickness of the cell walls may be about 0.35 to 0.5 μm.

Upon calculation using Equation (1) above, while conventional urethanes have a thermal conductivity of 20 to 22 mW/m·K, a thermal conductivity λᵤᵣₑₜₕₐₙₑ of the urethane according to an embodiment of the present disclosure may be about 18.0 to 20.5 mW/m·K. Therefore, as thermal insulation performance is improved by reducing the thermal conductivity by about 10% compared to conventional urethanes, energy-saving effects by 5% or more may be expected herein.

Hereinafter, a method of manufacturing urethane according to another embodiment of the present disclosure will be described.

A method of manufacturing urethane according to an embodiment comprises: forming a urethane polymer by reacting a polyol solution with isocyanate; and forming cells by adding a blowing agent and a foam stabilizer for cell formation, wherein a catalyst is used to control reaction rates of the urethane polymer-forming operation and the cell-forming operation, and the polyol solution, the isocyanate, the blowing agent, the foam stabilizer, and the catalyst may be comprised as follows: about 100 parts by weight of the polyol solution, about 100 to 120 parts by weight of the isocyanate, about 30 parts by weight or less of the blowing agent, about 1 to 3 parts by weight of the foam stabilizer, and about 1 to 8 parts by weight of the catalyst may be comprised based on the 100 parts by weight of the polyol solution.

First, the urethane polymer is prepared via a reaction between isocyanate and polyol as shown in Reaction Scheme 1 below.

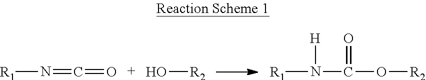

In addition, while the blowing agent is added to form inner pores, H₂O is used as a co-blowing agent to assist foaming, and therefore CO2 and an amine may be produced as shown in Reaction Scheme 2 below.

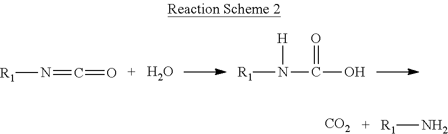

Meanwhile, the amine produced in Reaction Scheme 2 above is necessary in the following reaction, i.e., urea and biuret reaction. In the urea and biuret reaction, urea, biuret, and the like act as intermediate reactive groups to enhance physical binding strength of the urethane.

The polyol solution, the isocyanate, the blowing agent, the foam stabilizer, and the catalyst may be comprised as follows: about 100 parts by weight of the polyol solution, about 100 to 120 parts by weight of the isocyanate, about 30 parts by weight or less of the blowing agent, about 1 to 3 parts by weight of the foam stabilizer, and about 1 to 8 parts by weight of the catalyst may be comprised based on the 100 parts by weight of the polyol solution.

The polyol solution and the isocyanate may be added at a ratio of 1:1 to 1:1.2. In the case of using an excessive amount of the polyol solution, the polyol remains in a reaction process, resulting in an increase in density of final urethane and a decrease in production efficiency. On the contrary, in the case of using an excessive amount of the isocyanate, urethane considerably hardens, and cell refinement may not sufficiently occur.

The blowing agent plays a role in forming cells inside the urethane and the foam stabilizer plays a role in maintaining the formed cells via surfactant action. In the case of using excessive amounts of the blowing agent and the foam stabilizer, manufacturing costs may increase and productivity may decrease.

The catalyst plays a role in increasing or decreasing a reaction rate. An excess of the catalyst may decrease efficiency and raise manufacturing costs.

In the method of manufacturing urethane according to an embodiment, a cream time (CT) may be about 3 to 10 seconds, a gel time (GT) may be about 20 to 60 seconds, and a gel time (GT)/cream time (CT) ratio may be about 2 to 20.

One of the core technologies of the present disclosure is cell refinement implemented by controlling the CT, GT and GT/CT ratio. In the present disclosure, the CT and the GT are measured using any method well known in the art.

CT refers to a period from a point at which foams start to form to a point at which color change of a reaction solution is visibly recognized as foams grow. In this regard, the point at which the color change is visibly recognized refers to a point at which an ΔE value of the L*a*b* color space exceeds 1 in comparison with the color of the solution at the point where foams start to form.

GT refers to a period from a reaction start time of a reaction solution to a point where urethane fibers are formed and cured.

In response to a CT less than 3 seconds, urethane is quickly solidified to deteriorate flowability making it difficult to sufficiently fill the urethane. However, in response to a CT exceeding 10 seconds, it may be difficult to obtain desired thermal insulation performance of the urethane due to increased cell diameters. Preferably, the CT may be about 3 to 7 seconds.

In response to a GT less than 20 seconds, flowability of the urethane decreases making it difficult to fill the inside of a refrigerator with urethane and resulting in an excessive increase in density. However, in response to a GT exceeding 60 seconds, cell diameters increase making it difficult to obtain desired thermal insulation performance of the urethane. Preferably, the GT may be about 20 to 40 seconds.

In response to a GT/CT ratio less than 2, the density of the urethane excessively increases making it difficult to perform foaming. However, in response to a GT/CT ratio exceeding 20, the diameter of the cells increases making it difficult to obtain desired thermal insulation performance of the urethane. Preferably, the GT/CT ratio may be about 4 to 10.

The polyol solution may comprise about 20 to 80 parts by weight of an aromatic polyol solution, and a balance of aliphatic polyols based on the 100 parts by weight of the polyol solution.

Conventionally, although the aromatic polyols are added in an amount less than 20 parts by weight based on 100 parts by weight of the polyol solution, the amount of the aromatic polyols is increased to 20 to 80 parts by weight in the present disclosure to control the CT and the GT.

The blowing agent may comprise at least one of cyclopentane (CP), hydrofluoro-olefin (HFO), and hydrofluorocarbon (HFC).

The catalyst may comprise a foaming catalyst, a gelling catalyst, and a trimerization catalyst.

In the method of manufacturing a urethane according to an embodiment, the catalyst may comprise about 1 to 3 parts by weight of the foaming catalyst, about 1 to 3 parts by weight of the gelling catalyst, and a balance of the trimerization catalyst based on the 100 parts by weight of the polyol solution.

In the present disclosure, the catalyst may play a role in controlling the CT and the GT.

The foaming catalyst may control the CT by controlling foaming reaction between the isocyanate and water. The foaming catalyst may comprise at least one of pentamethyl diethylene triamine (PMDETA) and di-(N,N-dimethyl aminoethyl)ether (BDMEE).

The gelling catalyst may control the GT by controlling gelling reaction between the polyol and the isocyanate. The gelling catalyst may comprise at least one of triethylamine (TEA), triethylenediamine (TEDA), pentametylenediethylene triamine (PMDETA), dimethylcyclohexyl amine (DMCHA), and tetramethhyl-n-hexyldiamine (TMHDA).

The trimerization catalyst may play a role in controlling trimerization reaction in which 3 isocyanate molecules react to form isocyanurate. The trimerization catalyst may comprise at least one of potassium otoate and TMR-2.

Hereinafter, a refrigerator according to another embodiment of the present disclosure will be described.

The refrigerator according to an embodiment comprises: an outer cabinet; an inner cavity within the cabinet; and a urethane between the outer cabinet and the inner cavity, wherein the urethane comprises a plurality of closed cells containing inside gas; a plurality of open cells connected to outside air; and cell walls disposed between the closed cells and the open cells or between the plurality of closed cells to connect the closed cells with the open cells or to connect the plurality of closed cells. Diameters of a closed cell of the plurality of closed cells and an open cell of the plurality of open cells may be about 100 to 200 μm.

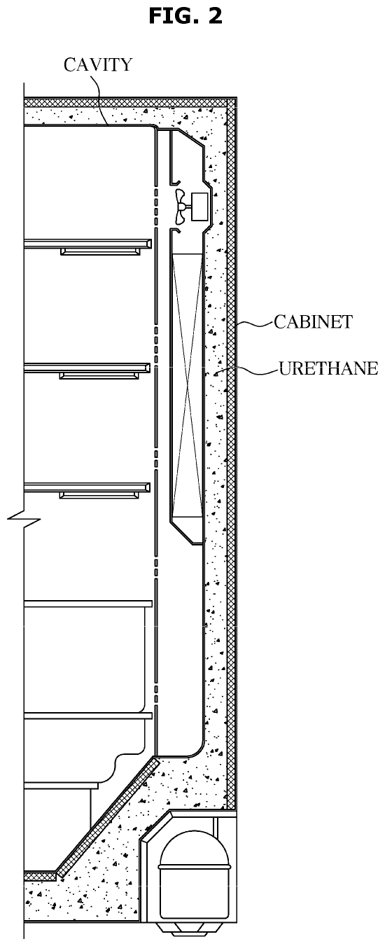

FIG. 2 is a schematic diagram illustrating a cross-section of a refrigerator according to an embodiment.

Referring to FIG. 2, the refrigerator according to an embodiment comprises an outer cabinet, an inner cavity within the outer cabinet, and a urethane between the outer cabinet and the inner cavity as an adiabatic material.

The outer cabinet may be made of steel and the inner cavity within the outer cabinet may be made of plastic.

A thermal conductivity λᵤᵣₑₜₕₐₙₑ is about 18.0 to 20.5 mW/m·K.

The urethane according to an embodiment may comprise, in fraction by volume, about 90% or more of the plurality of closed cells and a balance of the plurality of open cells, and the inside gas may comprise cyclopentane (CP), air, and hydrofluoro-olefin (HFO).

In addition, a density of the urethane may be about 30 to 35 kg/m³, and an average thickness of the cell walls may be about 0.35 to 0.5 μm.

Hereinafter, the present disclosure will be described in more detail with reference to the following examples and comparative examples. However, the following examples are merely presented to exemplify the present disclosure, and the scope and effects of the present disclosure are not limited thereto.

### EXAMPLES

Urethane samples were prepared using initial reaction solutions having composition ranges shown in Table 1 below. Units of the composition ranges of Table 1 below are based on 100 parts by weight of polyol solutions.

TABLE 1

| | | | | | Catalyst | | | |
|---|---|---|---|---|---|---|---|---|
| | Polyol | | Blowing | Foam | | | | Total content |
| | solution | Isocyanate | agent | stabilizer | Foaming | Gelling | Trimerization | of catalyst |
| Example 1 | 100 | 120 | 19 | 1.6 | 1.7 | 1.7 | 1.0 | 4.4 |
| Example 2 | 100 | 120 | 19 | 1.6 | 2.9 | 2.8 | 1.0 | 6.7 |
| Example 3 | 100 | 120 | 19 | 1.6 | 3.0 | 3.0 | 1.0 | 7.0 |
| Example 4 | 100 | 120 | 19 | 1.6 | 3.3 | 3.3 | 1.0 | 7.6 |
| Comparative | 100 | 120 | 19 | 1.6 | 0.5 | 0.5 | 1.0 | 2.0 |
| Example 1 | | | | | | | | |
| Comparative | 100 | 120 | 19 | 1.6 | 0.9 | 1.0 | 1.0 | 3.0 |
| Example 2 | | | | | | | | |

In Table 2 below, CT, GT, GT/CT ratio, cell diameter, and urethane density of each of the examples and comparative examples are shown.

CT refers to a period from a point at which foams start to form to a point at which color change of a reaction solution is visibly recognized as foams grow. In this regard, the point at which the color change is visibly recognized refers to a point at which an ΔE value of the L*a*b* color space exceeds 1 in comparison with the color of the solution at the point where foams start to form.

GT refers to a period from a reaction start time of a reaction solution to a point where urethane fibers are formed and withstand a light impact. Meanwhile, GT is measured based on SPI Gel Time.

The cell diameter of the samples was measured using a scanning electron microscope (SEM) image, and the density of urethane samples was measured by using a density meter at room temperature.

TABLE 2

| | | | | Cell | Urethane |
|---|---|---|---|---|---|
| | | | | diameter | density |
| | CT (s) | GT (s) | GT/CT | (μm) | (kg/m³) |
| Example 1 | 5 | 40 | 8 | 187 | 34.0 |
| Example 2 | 5 | 35 | 7 | 183 | 31.9 |
| Example 3 | 7 | 34 | 4.9 | 175.1 | 33.4 |
| Example 4 | 3 | 27 | 9 | 165 | 34.4 |
| Comparative | 20 | 100 | 5 | 360 | 33.6 |
| Example 1 | | | | | |
| Comparative | 11 | 55 | 5 | 250 | 33.7 |
| Example 2 | | | | | |

Referring to Table 2, because the samples of Examples 1 to 4 satisfied the composition range of the reaction solution according to the present disclosure, the CT range of 3 to 10 seconds, the GT range of 20 to 60 seconds, and the GT/CT ratio of 2 to 20 were satisfied. Thus, Examples 1 to 4 satisfied the cell diameter range of 100 to 200 μm. That is, it may be seen that thermal insulation performance was improved in Examples 1 to 4 by lowering thermal conductivity via cell refinement.

However, because the amounts of the foaming catalyst and/or the gelling catalyst of Comparative Examples 1 and 2 did not satisfy the range of 1 to 3, the CT range of 3 to 10 seconds, the GT range of 20 to 60 seconds, and the GT/CT ratio range of 2 to 20 were not satisfied. Therefore, the cell diameters of Comparative Examples 1 and 2 did not satisfy the range of 100 to 200 μm. That is, it may be seen that the thermal insulation performance was poor in Comparative Examples 1 and 2 due to insufficient cell refinement.

According to an embodiment, a urethane having improved thermal insulation performance by lowering thermal conductivity of the urethane via cell refinement conducted by controlling reaction time and a refrigerator comprising the same may be provided.

What is claimed is:

1. A urethane comprising:
a plurality of closed cells containing inside gas;
cell walls disposed
between at least one of the plurality of closed cells and at least one of the plurality of open cells or
between the plurality of closed cells to connect the at least one of the plurality of closed cells with the at least one of the plurality of open cells or to connect the plurality of closed cells,
wherein diameters of a closed cell of the plurality of closed cells and an open cell of the plurality of open cells are about 100 to 200 μm.

2. The urethane according to claim 1, wherein a thermal conductivity λᵤᵣₑₜₕₐₙₑ is about 18.0 to 20.5 mW/m·K.

3. The urethane according to claim 1, wherein the urethane comprises, in fraction by volume, about 90% or more of the plurality of closed cells and a balance of the plurality of open cells.

4. The urethane according to claim 1, wherein the inside gas comprises cyclopentane (CP), air, and hydrofluoro-olefin (HFO).

5. The urethane according to claim 1, wherein a density of the urethane is about 30 to 35 kg/m³.

6. The urethane according to claim 1, wherein an average thickness of the cell walls is about 0.35 to 0.5 μm.

7. A method of manufacturing a urethane, the method comprising:
forming a urethane polymer by reacting a polyol solution with isocyanate; and
forming cells by adding a blowing agent and a foam stabilizer for cell formation,
wherein a catalyst is used to control reaction rates of the urethane polymer-forming operation and the cell-forming operation, and
the polyol solution, the isocyanate, the blowing agent, the foam stabilizer, and the catalyst are comprised as follows:
about 100 parts by weight of the polyol solution, about 100 to 120 parts by weight of the isocyanate, about 30 parts by weight or less of the blowing agent, about 1 to 3 parts by weight of the foam stabilizer, and about 1 to 8 parts by weight of the catalyst are comprised based on the 100 parts by weight of the polyol solution.

8. The method according to claim 7, wherein a cream time (CT) is about 3 to 10 seconds, and a gel time (GT) is about 20 to 60 seconds.

9. The method according to claim 7, wherein a gel time (GT)/cream time (CT) ratio is about 2 to 20.

10. The method according to claim 7, wherein the polyol solution comprises about 20 to 80 parts by weight of an aromatic polyol solution and a balance of aliphatic polyols based on the 100 parts by weight of the polyol solution.

11. The method according to claim 7, wherein the blowing agent comprises at least one of cyclopentane (CP), hydrofluoro-olefin (HFO) and hydrofluorocarbon (HFC).

12. The method according to claim 7, wherein the catalyst comprises a foaming catalyst, a gelling catalyst, and a trimerization catalyst.

13. The method according to claim 12, wherein the catalyst comprises about 1 to 3 parts by weight of the foaming catalyst, about 1 to 3 parts by weight of the gelling catalyst, and a balance of the trimerization catalyst based on the 100 parts by weight of the polyol solution.

14. The method according to claim 12, wherein the foaming catalyst comprises at least one of pentamethyl diethylene triamine (PMDETA) and di-(N,N-dimethyl aminoethyl)ether (BDMEE),
the gelling catalyst comprises at least one of triethylamine (TEA), triethylenediamine (TEDA), pentametylenediethylene triamine (PMDETA), dimethylcyclohexyl amine (DMCHA), and tetramethhyl-n-hexyldiamine (TMHDA), and
the trimerization catalyst comprises at least one of potassium otoate and TMR-2.

15. A refrigerator comprising:
an outer cabinet;
an inner cavity within the outer cabinet; and
a urethane between the outer cabinet and the inner cavity, the urethane comprises:
a plurality of closed cells containing inside gas;
a plurality of open cells connected to outside air; and cell walls disposed
between at least one of the plurality of closed cells and at least one of the plurality of open cells or
between the plurality of closed cells to connect the at least one of the plurality of closed cells with the at least one of the plurality of open cells or to connect the plurality of closed cells,
wherein diameters of a closed cell of the plurality of closed cells and an open cell of the plurality of open cells are about 100 to 200 μm.
